(19) United States
(12) Patent Application Publication
(10) Pub. No.: US 2005/0108095 A1
(43) Pub. Date: May 19, 2005

(54) System and method for electronic advertising, advertisement play tracking and method of payment

(75) Inventor: Thomas Perlmutter, Calabasas, CA (US)

Correspondence Address: PILLSBURY WINTHROP LLP, 725 S. FIGUEROA STREET, SUITE 2800, LOS ANGELES, CA, 90017, US

(73) Assignee: ADICUS MEDIA. INC.

(21) Appl. No.: 10/963,963

(22) Filed: Oct. 13, 2004

Related U.S. Application Data
(63) Continuation-in-part of application No. 09/634,219, filed on Aug. 9, 2000.

(51) Int. Cl. G06F 17/60

(52) U.S. Cl. 705/14

(57) ABSTRACT

The present invention relates to a system and method for playing electronic advertisements in conjunction with other content deliverable through a communication network. The present invention is further directed to a method and system for tracking playing of an advertisement and using the play tracking information to determine the amount to be charged to an advertising client. In embodiments of the invention, the advertisement may be played upon the occurrence of a triggering event and removed from display to a viewer upon the occurrence of another triggering event. According to an embodiment of the present invention, playing of an advertisement may limit a viewer's access to other displayed content. The present invention may also incorporate a timing function such that a viewer is only shown an advertisement after a specified time has elapsed since the viewer was last shown an advertisement. The present invention may also incorporate a play-history window such that a viewer may be able to link to advertisements which they have already seen, in the case that they wish to view the advertisements again.

### RELATED APPLICATION

This application is a continuation-in-part of application Ser. No. 09/634,219, filed Aug. 9, 2000.

### BACKGROUND

Currently, the predominant form of advertising on the Internet is the “banner ad.”A banner ad may include text or graphics, possibly animated, and is generally displayed on a fixed portion of a webpage. Thus, as the webpage user scrolls down through the webpage, the user loses sight of the banner ad. Furthermore, as users go to various webpages, the banner ads on a particular webpage may change. Thus, if a user sees a banner ad on one webpage, visits a second webpage and then returns to the first webpage, the banner ads on the first webpage at the time of the first visit will have been removed and replaced with completely different banner ads. When a banner ad is removed, generally no link to information about the sponsors product is left on the webpage. For these reasons, banner ads generally leave a minimal impression on the user/consumer.

In addition, there is generally little information provided to allow a banner advertising client to determine when a banner ad is being displayed, whether it was viewed by the consumer, or the identity or location of the user to which the ad was displayed, etc. Therefore, banner advertising clients were generally charged according to the number of users received by the website or webpage displaying the banner ad, the size and other characteristics of the banner ad itself, the frequency at which the banner ad is to appear, and the duration of time (e.g., a week, a month) over which the banner ad is to intermittently appear on the website/webpage.

Another type of Internet advertisement in a timed advertisement, such as the SUPERSTITIAL advertisement offered by Unicast, Inc. of New York City, N.Y. SUPERSTITIAL advertisements consist of animation, audio and/or rich graphics files. A Web user may access the website on which the SUPERSTITIAL advertisement is to be displayed. When the Web user becomes idle (i.e., their modem/connection for gathering content from the website is not being used), the SUPERSTITIAL advertisement is downloaded to the Web user's remote terminal for storage in cache memory. Downloading of the SUPERSTITIAL advertisement may be halted if the Web user performs an action or makes a request that requires use of the modem/connection and may be restarted once the action or request is completed. When the Web user attempts to access another webpage, the SUPERSTITIAL advertisement is played from the cache memory in a pop-up window, i.e., an advertisement window having a separate source code from that of the main content window must be displayed on the Web user's display device. The Web user may interrupt and terminate play of the SUPERSTITIAL advertisement at any time. The operator of the website may report the number of times an ad was downloaded or launched, the number of times the Web user accessed the website of the advertising client from the advertisement and the interactivity of the Web user.

### BRIEF DESCRIPTION OF THE DRAWINGS

FIG. 1 depicts elements of a system and method for displaying an advertisement according to an embodiment of the present invention;

FIG. 2A illustrates a sample of a main content layer that may be displayed to a user according to an embodiment of the present invention;

FIG. 2B illustrates a sample of an advertisement layer that may be displayed to a user according to an embodiment of the present invention;

FIG. 2C illustrates the result of displaying an advertisement layer and a main content layer according to an embodiment of the present invention;

FIG. 3 is a flowchart depicting the process by which a user terminal may play an advertisement and transmit play tracking information according to an embodiment of the present invention;

FIG. 4 illustrates a play tracking data record according to an embodiment of the present invention;

FIG. 5 illustrates an advertisement record of the type that may be maintained in an advertisement medium in an embodiment of the invention;

FIG. 6 is a flowchart depicting a process of a timing element according to an embodiment of the present invention; and

FIG. 7 illustrates the play-history window according to an embodiment of the present invention.

### DETAILED DESCRIPTION

The present invention relates to the playing of electronic advertisements on display devices. It describes a system and method for playing an advertisement that may incorporate video images, text, audio files and/or other media content (“advertisement content”) and charging an advertising client for the playing of such advertisements. The visual advertisement content may be played on a portion of the display device on which content other than advertisement content (“main content”) is or was being displayed. Data indicating that the advertisement was played, on which display device the advertisement was played, what main content was displayed as the advertisement was played, the start and/or end time of the playing of the advertisement, the location or identity of the viewer of the advertisement and other similar play tracking information may be centrally stored and used for billing purposes, website/webpage evaluation or rating purposes, and the like. The present invention may further include timing technology which will allows a viewer to be shown additional advertisements after a specified amount of time has elapsed since the last advertisement was displayed. The timing between advertisements may change as the viewer delves deeper into a website and the timing technology will even keep track of the time between advertisements as the viewer accesses other websites with the necessary software installed. The present invention may also have a play-history link whereby the viewer may be able to access advertisements that have already played on the viewer's computer. The present invention further relates to a method whereby electronic advertising clients may be charged according to the number of times advertisements are successfully played rather than the number of times the associated website/webpage or advertising content is downloaded or launched.

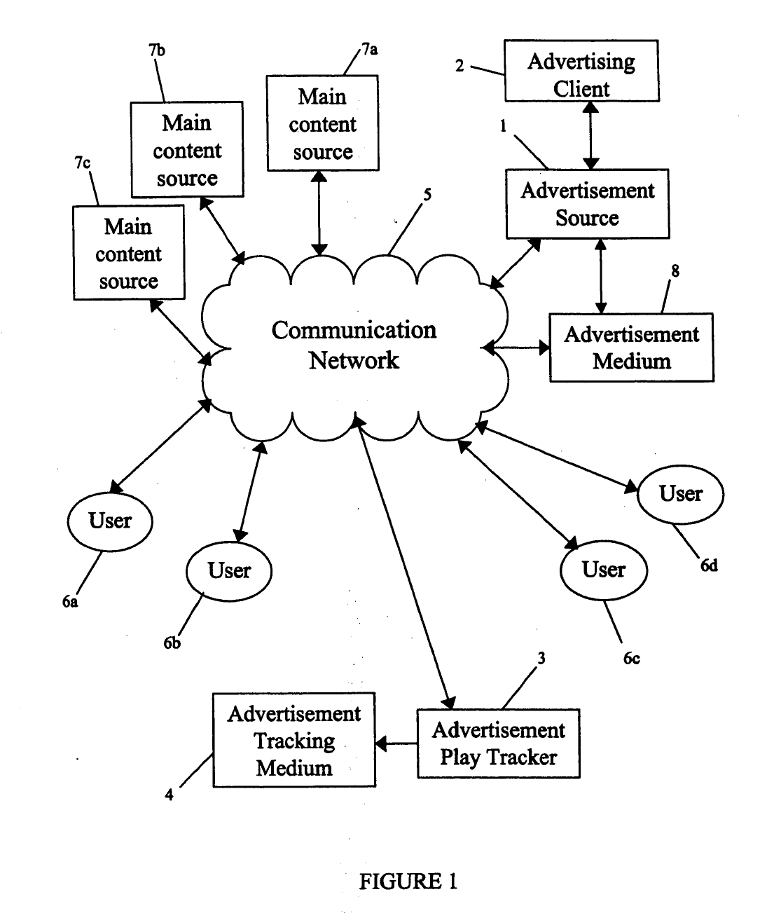

FIG. 1 depicts a network of computers that may be used to play electronic advertisements according to an embodiment of the present invention. A communication network 5 may connect a number of main content sources 7a-7c (collectively, 7), user terminals 6a-6d(collectively, 6), an advertisement source 1, an advertisement medium 8, and an advertisement play tracker 3 for the communication of messages, data or other information related to an advertisement sponsored by an advertising client 2. In embodiments of the invention, the advertisement play tracker 3 may be combined with either the advertisement source 1, one or more of the main content sources 7 or a combination thereof. Furthermore, in embodiments of the invention, the advertisement medium may not be directly connected to the communication network and may instead be accessible only through the advertisement source 1 or one or more of the main content sources 7.

The communication network 5 may be a local area network (LAN), metropolitan area network (MAN), wide area network (WAN), the Internet or any other type of computer network and may use any network implementation, including, for example, the Ethernet, ARCnet, and Token Ring implementations. Information communicated over the communication network 5 may conform to any data communications protocol, including TCP/IP, ATP, IPX/SPX, NetBios and AppleTalk. Communication network 5 may include wire line (such as twisted-pair telephone wire, coaxial cable, electric power line, optical fiber wire, leased line or the like) or wireless (such as satellite, cellular, radio frequency or the like) connections.

In an embodiment of the invention, users using browser software, such as Internet Explorer manufactured by Microsoft Corporation or Navigator manufactured by Netscape Corporation may access a website hosted by one of the main content sources 7 (typically an website or application server). The website may include several webpages, each of which may include main content in the form of video or other images for display. The user terminals 6 may include display devices (such as CRT monitor, flat-panel displays or liquid crystal displays) and the browser software operated at the user terminals 6 may execute instructions (“webpage source code”), such as an HTML instructions, JavaScript or Java applet, to cause these webpages to be displayed on the display devices.

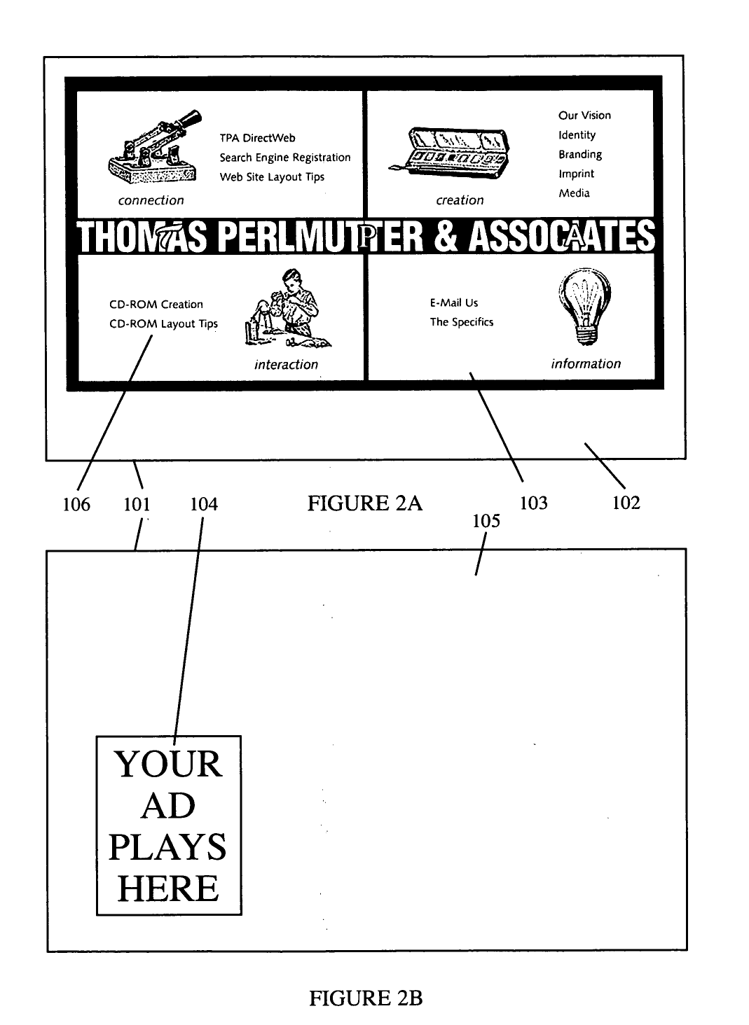

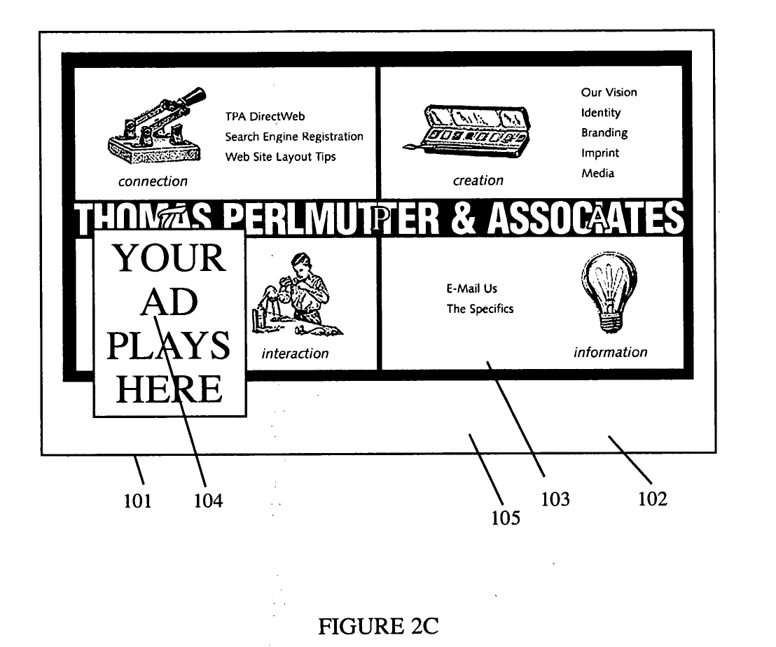

In such an embodiment of the present invention, a main content source 7 may include within the webpage source code, instructions for playing an advertisement sponsored by an advertising client 2. In an embodiment of the present invention, the instructions contained in the webpage source code may consist of only three lines of code. The webpage may include multiple HTML layers and the visual advertisement content 104 may be contained in a separate HTML layer (“the advertisement layer 105”) from the HTML layer(s) containing the remainder of the webpage content 103 (the “main content layer(s) 102”). Examples of an advertisement layer 105 and a main content layer 102 are shown in FIGS. 2A and 2B. An HTML layer, such as the main content layer 102 or the advertisement layer 105 may be displayed on a screen 101 when the visibility settings associated with these layers are set to “visible.” The z-index values of various layers may be set so as to create a stacking order. For example, the top layer in the stack may have a z-index value of 1, the next layer 2, and so forth. The advertisement layer 105 may have a z-index value indicating that it is higher in the stack than one or all of the main content layer(s) 102. Alternatively, the position of the advertisement layer 105 in the layer stack may be set relative to a main content layer 102. In order to display the advertisement, the visibility setting for the advertisement layer 105 may be changed to “visible,” producing the image shown in FIG. 2C. Similarly, to stop displaying the advertisement, the visibility setting for the advertisement layer 105 may be reset to “invisible.”

The visual advertisement content 104 may be displayed in a portion of the advertisement layer that is smaller than the entire screen area. In an embodiment of the invention., the advertisement layer 105 may be clipped so as to conform to the size of the visual advertisement content 104. Alternatively, where the size of the visual advertisement content 104 may change from advertisement to advertisement or within a single advertisement, the advertisement layer 102 may have an area substantially equal to the area of the screen 101 and the portions of the advertisement layer 102 that do not contain visual advertisement content 104 may be set to be transparent. The portion of the advertisement layer that corresponds to the visual advertisement content 104 may be characterized as “opaque,”preventing access to the portions of the main content layer(s) 102 directly underneath the visual advertisement content 104. For example, as shown in FIG. 2A, the main content layer may contain embedded links to other webpages or websites. Where the advertisement layer 105 contains visual advertisement content 104 that is opaque and the visual advertisement content 104 is displayed over a portion of a main content layer 102 containing embedded links, as shown in FIG. 2C, the user may be unable to activate the covered links.

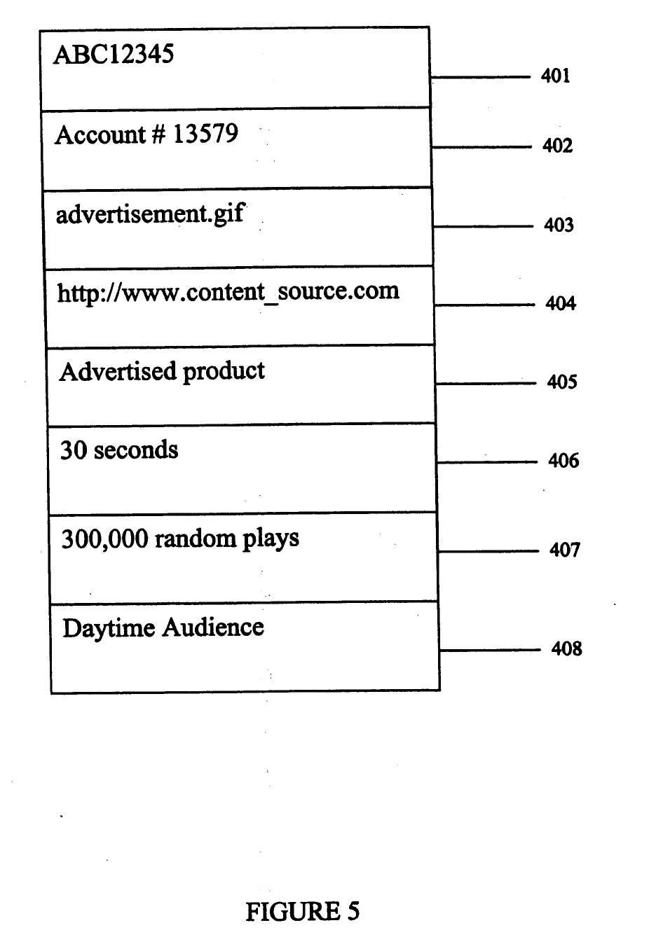

An advertisement source 1 may receive from an advertising client 2 information related to the advertisement to be played. The information may include visual or audio advertisement content (such as video image or audio clip files), information identifying the advertising client 2, characteristic information for the advertisement (e.g., the duration of the commercial, the desired number of times for the advertisement to be played, characteristics of the advertisement's target audience, sites on which the advertisement is to be played, and the like). In an embodiment of the invention, the advertisement source 1 may provide the advertising client 2 with software with which to create the advertisement and the information sent by the advertising client 2 to the advertisement source 1 may include the created advertisement. Alternatively, the advertisement source 1 may collect content components of the advertisement from the advertising client 2 and create the advertisement from these components or the advertisement source 1 may create the advertisement content components based on more basic information (e.g., product name, company name, product type, etc.) submitted by the advertising client 2. The advertisement source 1 may supplement the information submitted by the advertising client 2 with identification or registration information (e.g., a unique identification code or a registration code) or the like. The information submitted by the advertising client 2 and any supplemental information provided by the advertisement source 1 may be used to create an advertisement record to be stored in the advertisement medium 8. An example of an advertisement record according to an embodiment of the present invention is provided in FIG. 5.

Although the advertising client 2 and the advertisement source 1 are shown in FIG. 1 as directly linked, a person of ordinary skill in the art would readily understand that, in other embodiments of the invention, information sent by the advertisement source 1 to the advertising client 2 or vice versa may be transmitted over the communication network 5. Advertisement creation software and advertisement-related information may also be delivered on physical storage media such as floppy disks, CD-ROMs, flash memory and the like, or downloaded by the advertising client 2 from the advertising registrar 1 through the communication network 5.

An advertisement may include computer readable content files, such as a video image file (e.g., a GIF or MPEG file), an audio clip file (e.g., a MIDI file), a still image file (e.g., a JPEG file), a text file, and the like. The advertisement may also be associated with execution instructions (“play script”) to cause a user terminal 6 to display the advertisement at a predetermined time or upon the occurrence of a predetermined play triggering event (e.g., completion of the downloading of advertisement content, elapse of a period of time, user initiation of access to a different webpage or website, detection of an error or idle condition, a combination thereof, or the like). Similarly, the play script may cause the advertisement to be removed from display upon the occurrence of a predetermined removal triggering event. The play script may be in the form of a JAVA applet, an HTML instructions or the like. The execution instructions may also cause the advertisement to be removed from the display of a user terminal 6 at a predetermined time or upon the occurrence of a predetermined event, such as the detection of an error in playing the advertisement. The play script may include or cause to be created a timeline indicating the starting time and/or ending time for playing of the advertisement, starting and/or ending time of downloading an advertisement to the user terminal 6, the displaying and/or removal of the advertisement layer or the transmission of a play tracking message.

In an alternative embodiment of the invention, a play script for an advertisement may be incorporated into instructions for display of the main content (e.g., the webpage source code) associated with the advertisement to be played, creating a unified play script. Like a play script in an embodiment of the invention in which the display of the main content and the play of the advertisement are controlled by separate sets of instructions, the unified play script may include instructions for downloading an advertisement, playing an advertisement, removing an advertisement from display, recording play tracking information and transmitting a play tracking message. In an embodiment of the invention, the play script or unified play script may direct the user terminal to retrieve the advertisement content from a location in the advertisement medium 8. To direct the terminal to different advertisements, the location in the advertisement medium 8 may be fixed and the advertisement or advertisement content associated with the location may be changed, or alternatively, the location in the advertisement medium 8 may be changed. The advertisement to which the terminal is directed may be changed periodically or may be changed based on play tracking data instructions from the advertisement source 1, user- or user-terminal related information (e.g., the ZIP code of the internet service provider through which the user terminal 6 is establishing its connection to the main content source 7), or webpage-related information (e.g., a general webpage topic). In embodiments in which a unified play script is used, multiple advertisements may be downloaded to a user terminal 6 without requiring reloading of the entire webpage.

A play script or unified play script may also, for example, include information as to the placement of the advertisement on a display device associated with the user terminal (e.g., a CRT screen, flat-panel display, liquid crystal display or the like). In an embodiment of the invention, a play script or unified play script may also include a timeline according to which various advertisement-related events are to occur. For example, the timeline may indicate times at which an advertisement is to be downloaded, played and/or removed from display, or when a play tracking message is to be transmitted.

The advertisement source 1 or main content source 7 may also include instructions in the play script or unified play script directing a user terminal 6 to record information regarding playing of the advertisement. The recorded information may include the time at which playing of the advertisement started and/or ended, the time at which the advertisement layer was made visible and/or invisible, the identification code associated with the advertisement and information related to the webpage or website on which the advertisement was viewed (such as the Uniform Resource Locator associated with the webpage), and/or similar information. The recorded information, or a portion thereof, may be transmitted as a play tracking message to a advertisement play tracker 3. In alternative embodiments of the invention, a tracking message may first be sent to a main content source 7 associated with the webpage or website on which the advertisement was played and the tracking message (or information related to one or more such tracking messages) may subsequently be transmitted to the advertisement play tracker 3. For example, a main content source 7 may receive a number of tracking messages within a specified period of time and, at the end of the specified period, send another tracking message to the advertisement play tracker 3 including aggregated play information (e.g., the total number of times the advertisement was played during the specified period) based on the information in the individual tracking messages received by the main content source 7 from the user terminals 6. The tracking messages may be transmitted by the user terminal 6 after each playing of an advertisement, after the playing of a specified number of advertisements, upon the occurrence of a specified event (e.g., the user terminal discontinuing access to the webpage or website), upon the passage of a specified period of time, or the like.

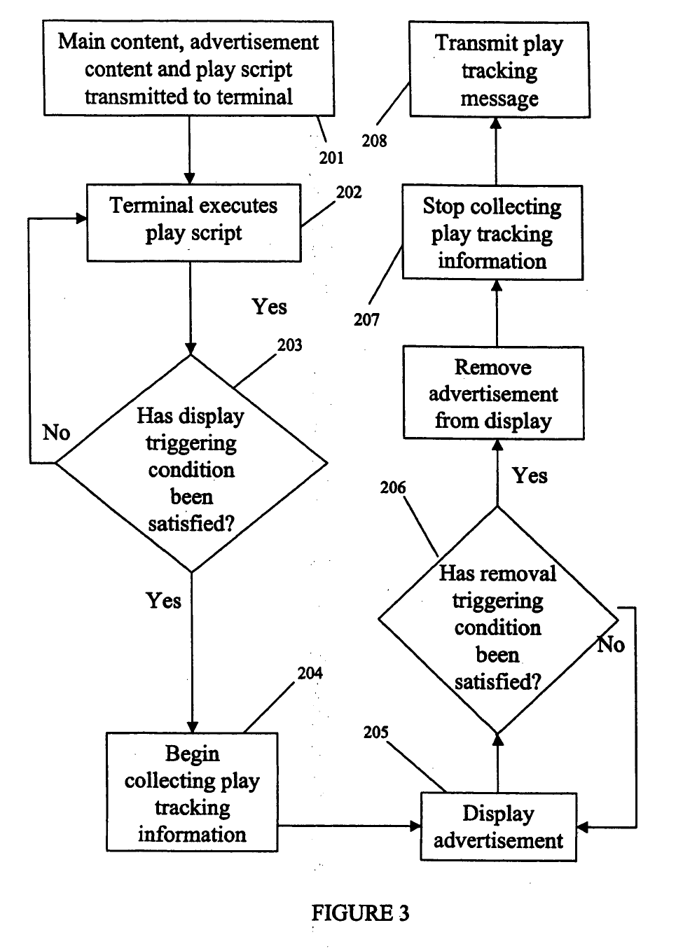

FIG. 3 is a flowchart of a process by which a user terminal 6 may display an advertisement and collect and transmit play tracking information according to an embodiment of the present invention. As shown in block 201, main content, advertisement content and a play script may be transmitted to the user terminal 6 from one of the main content sources 7, the advertisement source 1, or a combination thereof. Once the play script has been transmitted to the user terminal 6., the user terminal 6 may begin to execute the instructions in the play script, as shown in block 202. In an embodiment of the invention, the user terminal 6 may receive the play script and begin executing it before receiving the advertisement content. The play script may direct the user terminal 6 to retrieve the advertisement content from the advertisement source 1 or the main content source 7 and may provide information (such as file locations, passwords, and advertisement identification information) for the user terminal 6 to use in retrieving the advertisement content.

If the user terminal determines that a play triggering condition has been satisfied in block 203, the user terminal may begin collecting play tracking information and cause the advertisement to be displayed (as shown in blocks 204 and 205). The play triggering condition may be specified in the play script. Play tracking information may include the start and end time of play of the advertisement, whether the advertisement was successfully played to completion, information related to user interaction with the user terminal during the playing of the advertisement, and the like. Some elements of play tracking information, such as the geographical location of the terminal, may be collected and transmitted to the main content source 7, the advertisement tracker 3 or the advertisement source 1 prior to playing of the advertisement and may be used in the process of selecting advertisement content to be transmitted to the user terminal.

When the advertisement is being played, the user terminal 6 will continue play until determining that a removal triggering condition has been satisfied (block 206) Upon satisfaction of the removal triggering condition, the user terminal 6 may terminate play of the advertisement, remove visual advertisement content from the display and stop collecting play tracking information (as shown in blocks 207 and 208). The removal triggering condition may be specified in the play script. The removal triggering condition may be the passage of a specified length of time from the advertisement play start time, the detection of an error condition in the user terminal 6 display functions, or the like (or some combination thereof). The user terminal may then process the play tracking information and transmit it to the main content source 7, the advertisement play tracker 3 and/or the advertisement source 1. The user terminal 6 may transmit play tracking information periodically or after each advertisement playing.

An advertisement may be randomly selected for play on a particular user terminal 6. Alternatively, advertisements may be classified according to target audience, play frequency, price range and the like and selected for play based on the selection criteria corresponding to the classification information. The main content source may determine the order in which advertisements will be played with the display of main content for its website/webpage. A play schedule may be automatically created based on a total number of times the advertisement is to be played with the main content.

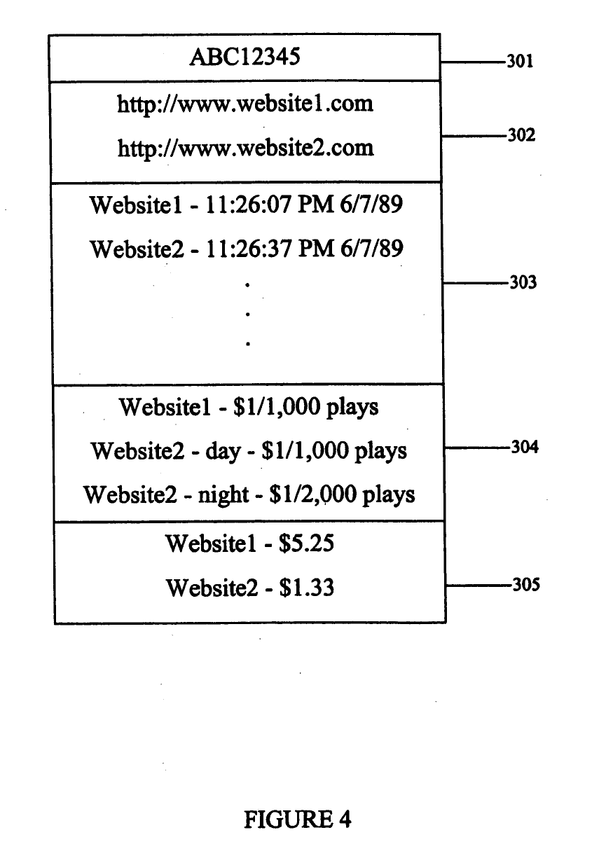

The advertisement play tracker may store tracking information related to the information contained in the tracking messages it receives from user terminals 3, main content sources 7, a combination thereof, or similar tracking information sources. The tracking information may be stored in an advertisement tracking medium 4 in the form of database records. A sample database record is shown in FIG. 4. The advertisement identification element 301 may contain information identifying the advertisement with which the tracking information contained in the record is associated. This information may include the advertisement's unique identification code, the name of the advertising client 2, an advertising account number, and/or the like. Main content source information element 302 may include information related to one or more main content sources 7 that have played or will play the advertisement. As shown in FIG. 3, main content source information element may include the Uniform Resource Locator (URL) of a webpage on which the advertisement was played. The main content source information element 302 may also include information related to the target audience of each of the main content sources 7. Play information element 303 may contain information as to a single playing of an advertisement or may contain aggregated information as to all plays of an advertisement associated with a main content source(s) 7 identified in main content source information element 302 for a particular time period. Play information may be categorized by main content source. The play information element 7 may include play information related to play conditions set by the advertising client 2 and/or advertisement source 1. For example, play information element 303 may include information limiting playing of the advertisement to daytime hours or targeting an audience, e.g. female users or user within a particular geographical region. Rate information element 304 may contain information related to the advertising rate charged for playing an advertisement on a website operated by the main content source(s) 7 identified in main content source information element 302. Charge element 305 may indicate the charge to be assessed to the advertising client 2 based on predetermined advertising rates associated with each of the main content sources 7, the charge may be calculated per playing event or for a specified time period. The charge may also be calculated separately for each main content source.

Once the advertisement has been created and submitted to the advertisement source 1, the advertisement source 1 may tag the advertisement with a unique identification code, such as an alphanumeric code. The identification code, or a portion thereof, may indicate the identity of the advertising client 2 or the product being advertised, the date or time period in which the advertisement is to be played, and other similar information. Alternatively, the identification code, or a portion thereof, may be randomly generated. In an alternative embodiment, software distributed by the advertisement source 1 to an advertising client 2 may automatically tag the advertisement with the unique identification code and incorporate play tracking message transmission instructions into the play script.

The advertising source 1 may also tag the advertisement with a registration code. The advertisement may be tagged with a registration code after the advertising client has agreed to terms and conditions of playing of the advertisement, after the advertisement content has been examined to ensure that it contains appropriate material, after the advertising client made an initial payment, after an account has been set up for the advertising client, or the like. A main content source 7 may determine whether an advertisement has been tagged with the proper registration code before allowing advertisement content associated with the advertisement to be downloaded to a user terminal 6 displaying the main content for its webpage/website. In this way, the registration code may be used to ensure that unauthorized advertisements are not played using the system of the present invention.

Moreover, the advertisement source 1 may tag the advertisement with an expiration code. The expiration code may be a binary flag indicating whether the advertisement is still available for play. The expiration flag may be set to indicate that the advertisement is not available for play after the advertisement has been played a desired number of times or for a desired period of time, if the advertising client is delinquent in payment of charges to its account, or under similar circumstances. As discussed with respect to the registration code, the main content source 7 may check to ensure that the expiration code indicates that the advertisement is available for play before allowing advertisement content associated with the advertisement to be downloaded to a user terminal 6 displaying the main content for its webpage/website.

FIG. 5 illustrates a record associated with an advertisement that may be maintained in the advertisement medium according to an embodiment of the invention. The record for an advertisement, or a portion thereof, may be made accessible to a main content source 7 if the advertisement is to be played in association with main content from the main content source 7. The record may include a advertisement identification element 401 containing information from which the advertisement may be identified, such as an identification code. The identification code or other information contained in the advertisement identification element may be unique and may be used in play tracking. An advertising client information element 402 may include the name of the advertising client 2, an account number associated with the advertising client 2, contact information for the advertising client 2, and the like. The advertisement data element 403 may contain computer readable advertising content files or may list the name or location of such files. The files may be in Graphics Interchange Format (GIF), Portable Network graphic (PNG), Moving Picture Experts Group (MPEG), Joint Photographic Experts Group (JPEG), or other video, graphic and/or audio file formats.

Main content information element 404 may indicate the source of the main content with which the advertisement is to be played. In an embodiment of the invention, the main content information element may contain the URL(s) for one or more websites or webpages. A product information element 405 may identify the product or service that is the subject of the advertisement. In an embodiment of the invention, product information may be included in the advertising client information element 402 and the record need not include a separate product information element 405. A advertisement duration information element 406 may contain information indicating the run time of the advertisement. The information contained in the advertisement duration element 406 may be used to create instructions or set a timeline in a play script or unified play script to control events such as the displaying and removal of the visual advertisement content. In an embodiment of the invention, the instructions for removing the advertisement from display may cause the advertisement to be removed from display a specified amount of time (based on the advertisement's duration) after the advertisement is first displayed or playing of the advertisement begins. In such an embodiment, the advertisement may be removed from display automatically (i.e., without action by the user) even if an error occurs in the middle of playing the advertisement. In an alternative embodiment, the instructions for removal of the advertisement from display may cause the advertisement to be removed from display after the advertisement has finished playing.

A play schedule information element 407 may contain information related to the number of times the advertisement is to be played. The information may be categorized according to main content source, conditions of play, time period and the like. The play schedule information element 407 may contain a file (or the location or name of a file) containing the play schedule for one or more advertisements. The play schedule information element 407 may contain a count of the number of times the advertisement is to be played. Such a count may be decremented as play tracking information verifying plays successful plays of the advertisement is received.

A record may also include a play condition information element 408. The play condition information element 408 may contain information about the conditions under which the advertising client wishes to have the advertisement played. For example, the advertising client may specify a time of day, target audience, type of main content source, user terminal ZIP code range or other similar play condition. In an embodiment of the invention, play condition information contained in the play condition information element 408 may be used by the advertisement source to determine to which main content sources the advertisement should be distributed or access to the advertisement should be allowed. For example, if the play condition information element 408 contains target audience information indicating that the advertising client 2 is seeking a female target audience, the advertisement source may distribute the advertisement to main content sources 7 administering content oriented toward a female target audience. Play tracking information may also be used for other purposes, e.g., rating websites according to the amount of time spent by visitors viewing a particular webpage.

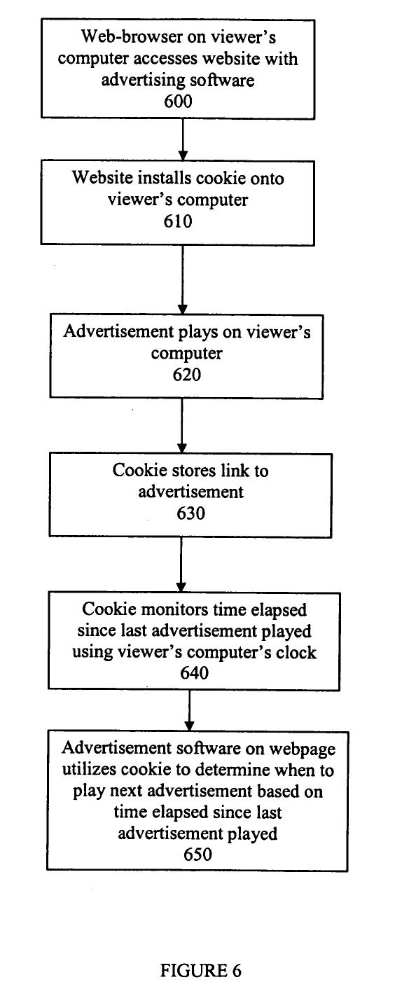

With reference to FIG. 6, in an embodiment of the present invention, when the web browser of a viewer's computer first accesses a website with the necessary advertisement software 600, a cookie is installed 610 on the viewer's computer. The cookie may be installed by the Advertisement Server, or it may be installed by the Website Server which hosts the webpage. When the advertisements play 620, the cookie may keep track of which advertisements have been played and store 630 a link to the advertisements. In an embodiment of the present invention, the advertisements are stored on the advertisement server, such that the link is to a location on the advertisement server. Additionally, using the viewer's computer's clock, the cookie may monitor 640 whether the advertisement played until near completion (around 75%) and how much time has elapsed since an advertisement was last displayed.

In conjunction with the software on the webpage, the cookie may be used to tell the advertisement server to display 650 another advertisement. For instance, if the software on the webpage dictates that an advertisement should be displayed every 5 minutes, then the cookie will be used to determine when 5 minutes has elapsed since the last advertisement was displayed. Once the five minutes have elapsed, a new advertisement will play and the cookie will reset the time that has elapsed since the last advertisement was displayed. The cookie may record that an advertisement played only if the advertisement played to near completion. In another embodiment, the cookie may record that an advertisement played according to a percentage set by the advertiser, such that if the advertiser believes that only 30% of the advertisement needs to be played then the cookie will record that an advertisement played if 30% of the advertisement played, but not 20%. If only 20% of the advertisement played in this scenario, then the cookie will not reset the time that has elapsed since the last advertisement played.

In one embodiment, if the website has several webpages, the operator or designer of the website may set a different specified time to elapse before playing another advertisement for different webpages throughout the website. That is, the first page may specify that an advertisement is to play every 10 minutes, then if the viewer of the page goes further into the website, the second page may specify that the an advertisement should play every 7 minutes, and that an advertisement should play every 5 minutes on the third page. As the viewer goes deeper into the website to retrieve the information the viewer desires, he may receive more and more frequent advertisements.

In an embodiment of the invention, the time that elapses between viewing of an advertisement is dependent upon the page that the viewer is currently on. Thus, if the viewer was on a page wherein an advertisement was set to play every 10 minutes, and the viewer had been viewing that page for 8 minutes and then the viewer accesses another page that states an advertisement should play every 5 minutes, the viewer will immediately be presented with an advertisement upon accessing the second page (because 5 minutes had already elapsed since the last advertisement was displayed). In an embodiment of the present invention, the cookie has the ability to track the user to different websites that have the particular code written into the page. Thus, if the viewer is on the CNN.com homepage for instance, (assuming the CNN.com homepage has the necessary software) and then the viewer accesses another website that also has the necessary software (say the New York Times homepage), then the viewer will be presented with another advertisement after the specified time as dictated by the New York Times webpage.

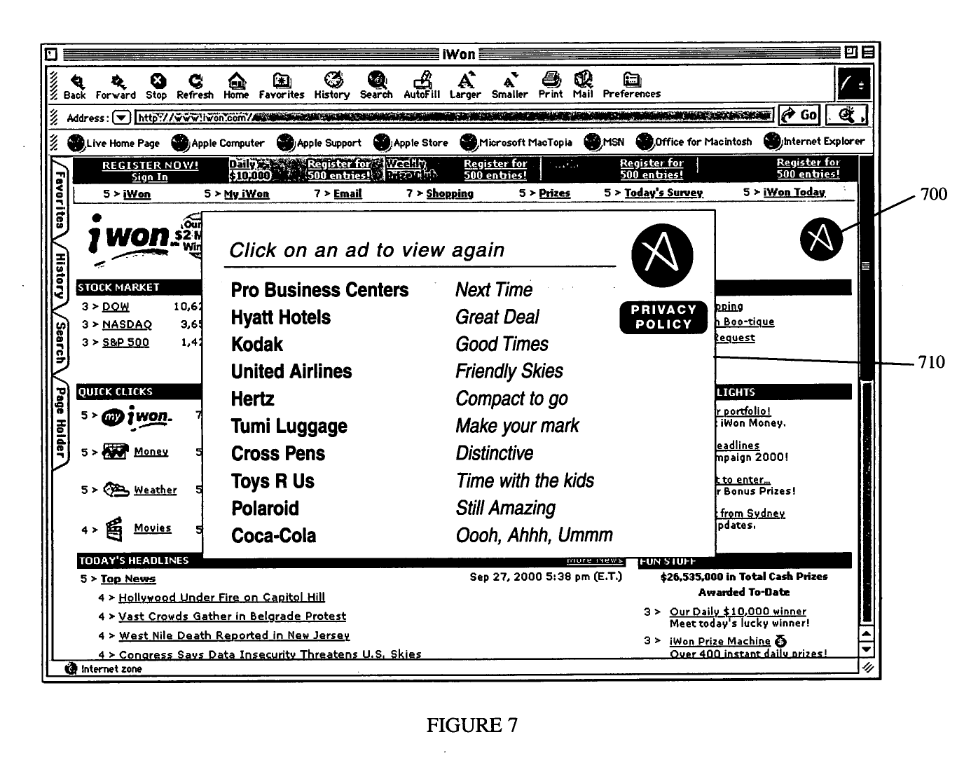

With reference to FIG. 7, webpages with the necessary software may have an icon or text 700 located on them that, when clicked, will display a window 710 in the viewer's browser that will display links to the advertisements which have already played on the viewer's computer. This is the play history link. The play history link allows viewers to view again advertisements which they have already seen. The play history link works in conjunction with the cookie, as the cookie actually stores the links. In one embodiment, the play history link may display links to the last ten advertisements that have played on the viewer's computer. In an embodiment of the present invention, the cookie maintains the links to the last ten advertisements that have played, regardless of whether the viewer closes the web browser or turns off the viewer's computer. The play history link allows the viewer instant recall at a later time of any of the advertisements the user may want to experience again.

In an embodiment of the present invention, when the a viewer chooses to view a past commercial using the play history link, the cookie does not register that a commercial has played and thus does not reset the time elapsed since the last commercial played. However, in this embodiment, the advertiser may still get billed for the showing of the advertisement.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

1. A computer readable medium having encoded thereon a computer-readable program code which when executed causes:
a cookie to be sent to and stored on a memory in a viewer's computer, the viewer's computer having a web browser;
an advertisement window to appear in the web browser of a viewer's computer;
an advertisement server to send at least one motion-picture advertisement to the viewer's computer, the at least one motion-picture advertisement being displayed in the advertisement window; and
an advertisement play history link to appear on the web browser of the viewer's computer, the advertisement play history link displaying a link to at least the last motion-picture advertisement played in the advertisement window,
wherein the cookie stores information about at least the last motion-picture advertisement displayed in the advertisement window and is linked to the advertisement play history link.

2. The computer-readable medium of claim 1, wherein the computer-readable program code is a part of a source code that produces a website stored on a website server.

3. The computer-readable medium of claim 1, wherein the cookie is sent by an advertisement server.

4. The computer-readable medium of claim 2, wherein the computer-readable program code is no longer than three lines in length.

5. The computer-readable medium of claim 1, wherein the information stored on the cookie includes a link to the at least last motion picture advertisement.

6. The computer-readable medium of claim 1, wherein the viewer's computer further includes a clock and the cookie utilizes the clock to determine the amount of time that elapses after the last advertisement appeared on the viewer's computer.

7. The computer-readable medium of claim 6, wherein the computer-readable program code further includes instructions that when executed cause a second motion-picture advertisement to be sent to the viewer's computer by the advertisement server after a specified amount of time has elapsed since the last advertisement was displayed on the viewer's computer.

8. The computer-readable medium of claim 1, wherein the advertisement window cannot be closed by a user and the advertisement window stays in the same location on the screen of the viewer's computer when the viewer scrolls down the webpage.

9. The computer-readable medium of claim 2, wherein the computer-readable program code is executed by the web browser accessing the website stored on the website server.

10. A computer readable medium having encoded thereon a computer-readable program code which when executed causes:
a cookie to be sent to and stored on a memory in a viewer's computer, the viewer's computer having a web browser and a clock;
an advertisement window to appear in the web browser of a viewer's computer; and
an advertisement server to send a first motion-picture advertisement to the viewer's computer, and a second motion-picture advertisement to the viewer's computer after a specified period of time has elapsed since the first motion-picture advertisement was displayed on the viewer's computer, the motion-picture advertisements being displayed in the advertisement window,
wherein the cookie utilizes the clock to determine the amount of time that has elapsed since the first motion-picture advertisement was displayed on the viewer's computer.

11. The computer-readable medium of claim 10, wherein the computer-readable program code is a part of a source code that produces a website stored on a website server.

12. The computer-readable medium of claim 10, wherein the cookie is sent by the advertisement server.

13. The computer-readable medium of claim 11, wherein the computer-readable program code is no longer than three lines in length.

14. The computer-readable medium of claim 10, wherein the cookie further includes a link to at least the first motion-picture advertisement after the first motion-picture advertisement has been displayed on the viewer's computer.

15. The computer-readable medium of claim 10, wherein the computer-readable program code further includes instruction that when executed cause an advertisement play history link to appear on the web browser of the viewer's computer, the advertisement play history link displaying a link to at least the first motion-picture advertisement played in the advertisement window, and
wherein the cookie stores information about at least the first motion-picture advertisement displayed in the advertisement window and is linked to the advertisement play history link.

16. The computer-readable medium of claim 11, wherein the advertisement window cannot be closed by a user and the advertisement window stays in the same location on the screen of the viewer's computer when the viewer scrolls down the webpage.

17. The computer-readable medium of claim 11, wherein the computer-readable program code is executed when the web browser accesses the website stored on the website server.

18. A system for displaying an advertisement comprising;
a website server having a memory upon which is stored a website, the website being written in a source code;
an advertisement server storing a plurality of advertisements including a first advertisement and a second advertisement;
a viewer's computer have a web browser, a memory, and a clock; and
a communication network linking the website server, the advertisement server, and the viewer's computer, wherein when the web browser accesses the website, at least a portion of the source code causes a cookie to be sent and stored on the memory of the viewer's computer by the advertisement server and causes the advertisement server to send at least the first advertisement to be displayed in an advertisement window in the web browser and causes a play history link to be displayed in the web browser, said play history link displaying a link at least to the first advertisement, and
the cookie utilizes the clock on the viewer's computer to determine the amount of time that has elapsed since the first advertisement was displayed on the viewer's computer, and after a specified amount of time has elapsed, the second advertisement is displayed on the viewer's computer.

19. The system of claim 18, wherein the cookie is sent by the advertisement server.

20. The system of claim 18, wherein the portion of the source code is between three and twelve lines in length.

21. The system of claim 18, wherein the cookie further includes a link to at least the first advertisement after the first advertisement has been displayed on the viewer's computer.

22. The system of claim 18, wherein the advertisement window cannot be closed by a user and the advertisement window stays in the same location on the screen of the viewer's computer when the viewer scrolls down the webpage.

23. The system of claim 18, wherein the cookie tracks the beginning time and the ending time of the plurality of advertisements and sends a message to the advertisement server if at least one of the plurality of advertisements plays at least seventy-five percent through completion.

24. The system of claim 18, wherein the cookie tracks the beginning time and the ending time of the plurality of advertisements and sends a message to the website server if at least one of the plurality of advertisements plays at least seventy-five percent through completion.
